(19) United States
(12) Patent Application Publication
(10) Pub. No.: US 2008/0156878 A1
(43) Pub. Date: Jul. 3, 2008

(54) Optical Scanning Module

(76) Inventors: Schonenberg Cornelis Reinier J, Soesterberg (NL); Hermen Hendrik Nijzink, Soesterberg (NL)

Correspondence Address: HDSL, 4331 STEVENS BATTLE LANE, FAIRFAX, VA, 22033, US

(21) Appl. No.: 11/962,249

(22) Filed: Dec. 21, 2007

(30) Foreign Application Priority Data
Dec. 29, 2006 (TW) 095223180

(51) Int. Cl. G06K 7/10

(52) U.S. Cl. 235/462.32

(57) ABSTRACT

An optical scanning module of a barcode scanner includes an optical sensor; a lens drum, having an axle disposed longitudinally at the center of the lens drum, and several light reflecting surfaces around external sides of the lens drum; a mirror, having a reflecting plane disposed on a side of the lens drum, such that the reflecting plane faces one of light reflecting surfaces, and the mirror has a penetrating hole for passing the reflecting plane; and a light generator, for transmitting a light beam through the penetrating hole and projecting the light beam onto one of the light reflecting surfaces to refract the light beam to the barcode. The scanned light beam is returned to one of the light reflecting surface of the lens drum and refracted to the reflecting plane of the mirror. The reflecting plane reflects the returned light beam to be received by the optical sensor.

### BACKGROUND OF THE INVENTION

1. Field of the Invention

The present invention generally relates to a barcode reader, and more particularly to a scanning module employing charge couple device (CCD) technology and principle of optics to sense a barcode.

2. Description of Prior Art

As optical encoding technology advances, optical encoding information becomes popular, and one of the common optical encoding information is barcode which is a measure taken to substitute an input of number(s) or alphabet(s) from keyboard to computer. Users simply scan the barcode to directly input the number(s) and alphabet(s) into a computer without requiring a single stroke of the keyboard. A secret code arrangement such as a combination of wide and narrow bars (binary level) and a combination of widths of black lines and white portions (or spacings) between the black lines is read by a barcode scanner for carrying out an encoding, and transmitted and inputted into a computer. Barcode has been used extensively in our life, not just being used as a goods management tool for supermarkets, warehouses, distribution companies or as a payment slips for parking fees, credit card payments and many other payment slips, but also being used as a necessary input tool. For example, a barcode system is applied in a supermarket or warehouse, the barcode inputs the product code of a product to display the selling price of a product and count the inventory, sales volume and future order of the product by a computer of the barcode system, so that we can know about the current inventory well.

However, the architecture of common barcode readers used in the past usually come with a design that the range of its light path is very broad, so that the positions and relative distance between modules or components are farther, and the space occupied by modules and components in such arrangement is relatively greater, and thus it is difficult to meet the miniaturization requirement.

In view of the shortcomings of the prior art, the inventor of the present invention based on years of experience in the related field to conduct extensive researches and experiments, and finally developed an optical module to provide a feasible design and overcome the foregoing shortcomings of the prior art.

### SUMMARY OF THE INVENTION

It is a primary objective of the present invention to provide an optical scanning module of a barcode scanner, wherein a portion of the back and forth paths for light beams to travel is overlapped, such that the range of the overall light path can be reduced, and the relative distance and positions of the installed components of the optical scanning module can be reduced to decrease the space occupied by the installed the scanning module, so as to meet the miniaturization requirement.

To achieve the foregoing objective, the present invention provides an optical scanning module of a barcode scanner for scanning a barcode, and the optical scanning module comprises: an optical sensor; a lens drum, having an axle installed along the longitudinal direction and at the center of the lens drum and a plurality of light reflecting surfaces disposed continuously around external sides of the lens drum; a mirror, having a reflecting plane, disposed on a side of the lens drum, such that the reflecting plane faces one of the light reflecting surfaces, and the mirror has a penetrating hole for passing the reflecting plane; and a light generator, for transmitting a light beam through the penetrating hole of the mirror and projecting the light beam onto one of the light reflecting surfaces of the lens drum, and then refracting the light beam to the barcode. The scanned light beam is returned to any one of the light reflecting surface of the lens drum and refracted to the reflecting plane of the mirror, and the reflecting plane reflects the returned light beam to the optical sensor, and the optical sensor receives the light beam. Since a portion of the back-and-forth light path is overlapped, the range of the light path can be reduced to achieve the aforementioned objective.

### BRIEF DESCRIPTION OF DRAWINGS

FIG. 1 is a perspective view of a first preferred embodiment of the present invention;

FIG. 2 is a schematic view of the operation of a first preferred embodiment of the present invention;

FIG. 3 is a section view of Section 3-3 of FIG. 2;

FIG. 4 is a perspective view of a second preferred embodiment of the present invention;

FIG. 5 is a schematic view of the operation of a second preferred embodiment of the present invention; and

FIG. 6 is a perspective view of a third preferred embodiment of the present invention.

### DETAILED DESCRIPTION OF THE INVENTION

The technical characteristics, features and advantages of the present invention will become apparent in the following detailed description of the preferred embodiments with reference to the accompanying drawings. However, the drawings are provided for illustration and reference only, but not intended to limit the scope of the invention.

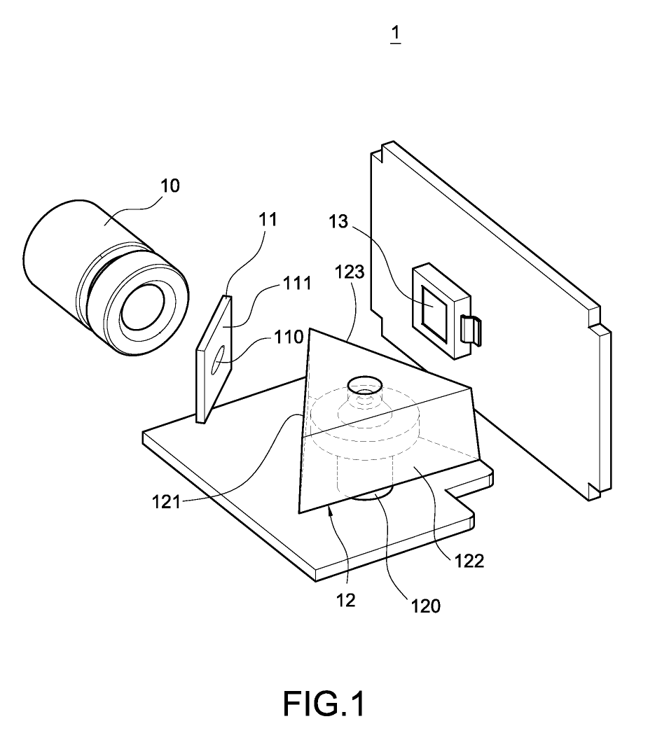

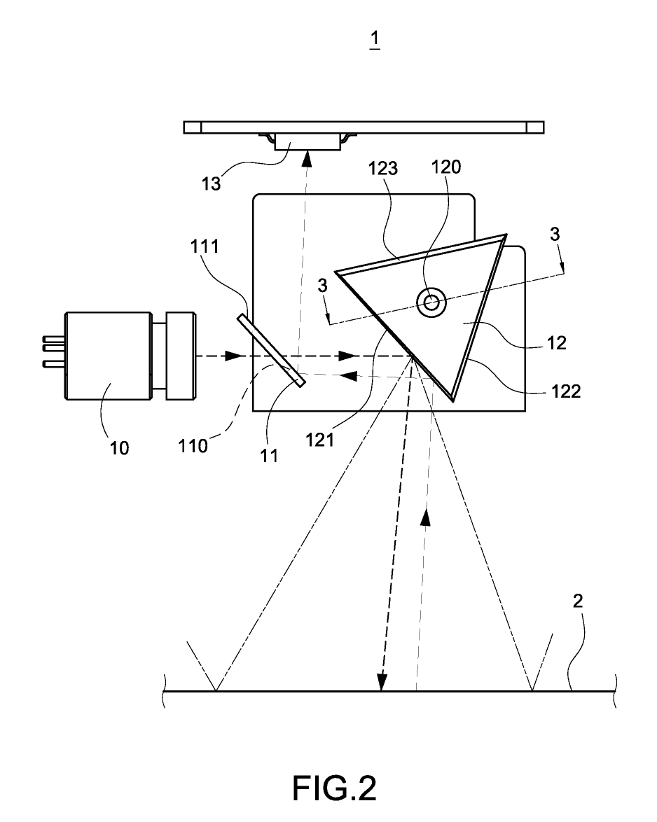

Referring to FIGS. 1 and 2 for a perspective view and a schematic view of the operation of a first preferred embodiment of the present invention respectively, the invention provides an optical scanning module of a barcode scanner, and the scanning module 1 comprises a light generator 10, a mirror 11, a lens drum 12 and an optical sensor 13.

The lens drum 12 comes with a three-dimensional configuration with its external sides continuously surrounded by at least three light reflecting surfaces 121, 122, 123, and has an axle 120 disposed longitudinally at the center of the lens drum 12, and the axle 120 is driven to rotate by a transmission device such as a motor (not shown in the figure), so that the lens drum 12 can be rotated synchronously with the rotation of the axle 120.

The mirror 11 has a reflecting plane 111 disposed on a side of the lens drum 12, such that the reflecting plane 111 can face any one of the light reflecting surfaces 121, 122, 123 of the lens drum 12. Meanwhile, the mirror 11 has a penetrating hole 110 thereon for passing the reflecting plane 111.

The light generator 10 is provided for transmitting a light beam such as a laser beam (as indicated by the bold dotted line in FIG. 2), and the light generator 10 of this embodiment is situated at the rear side of the mirror 11, so that after the produced light beam is passed through the penetrating hole 110 of the mirror 11 and projected onto one of the light reflecting surfaces 121, 122, 123 of the lens drum 12 to refract the light beam onto a desired scanning barcode 2. Since the lens drum 12 can rotate with its axle 120, the light reflecting surface 121, 122, 123 can be rotated with the lens drum 12 accordingly to change the angle of refraction for the light beam projected thereon, therefore a transverse scanning can be performed to the barcode 2, and the bright and dark zones of the barcode 2 provide different refractive indexes for the returned light beam (as indicated by the thin dotted line in FIG. 2) to facilitate reading the barcode 2 after the optical sensor 13 has received the returned light beam.

After the present invention projects the light beam onto the barcode 2, the returned light beam is projected onto one of the light reflecting surfaces 121, 122, 123 of the lens drum 12 and refracted onto the reflecting plane 111 of the mirror 11, and the reflecting plane 111 reflects the returned light beam to the optical sensor 13, so that the optical sensor 13 can receive the returned light beam and complete the operation of reading the barcode 2. Since a portion of the light path of the back-and-forth light beam is overlapped, the range of the overall light path of the light beam can be reduced to decrease the relative distance and positions of components of the assembly, and thus the space occupied by the installed scanning module 1 can be reduced to meet the miniaturization requirement.

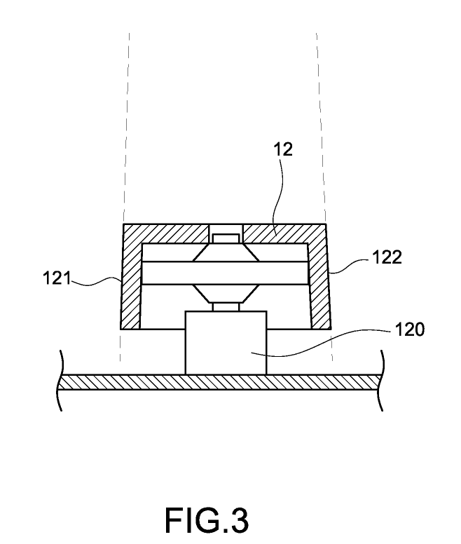

Referring to FIG. 3, each of the light reflecting surfaces 121, 122, 123 of the lens drum 12 forms a slope for facilitating the scanning module 1 to scan a barcode 2 with a greater width, and the slopes of the light reflecting surfaces 121, 122, 123 are different, so that the light beam projected thereon can produce the effect of refraction. Further, the barcode 2 can be scanned at a position where the width is not equal to the height after the refraction takes place because the slopes of the light reflecting surface 121, 122, 123 are different, and thus the barcode 2 with a greater width can be scanned.

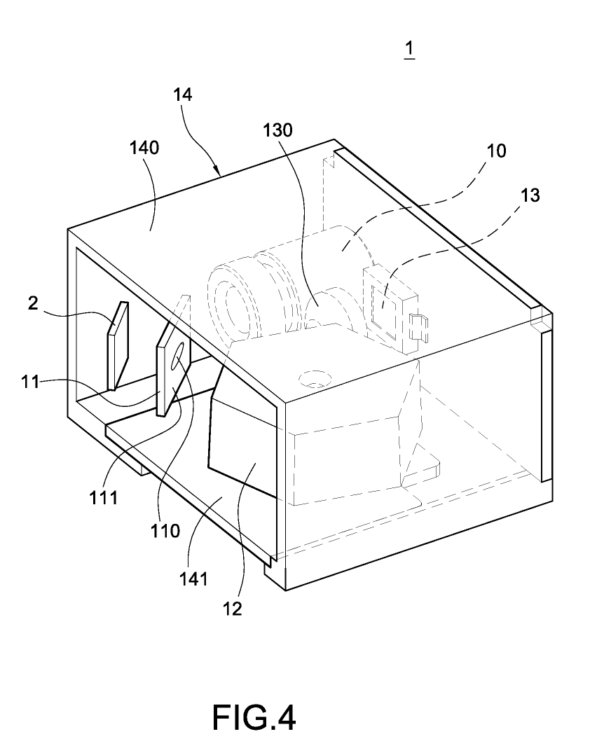

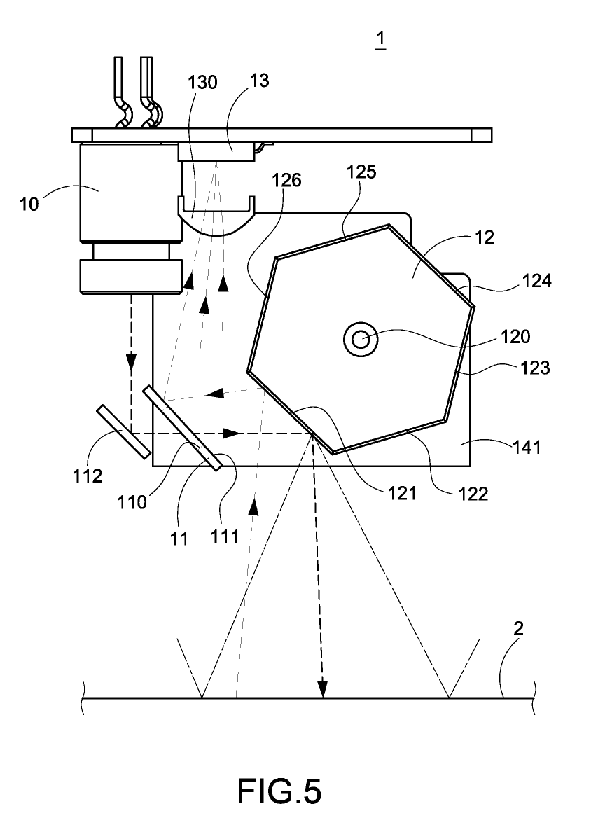

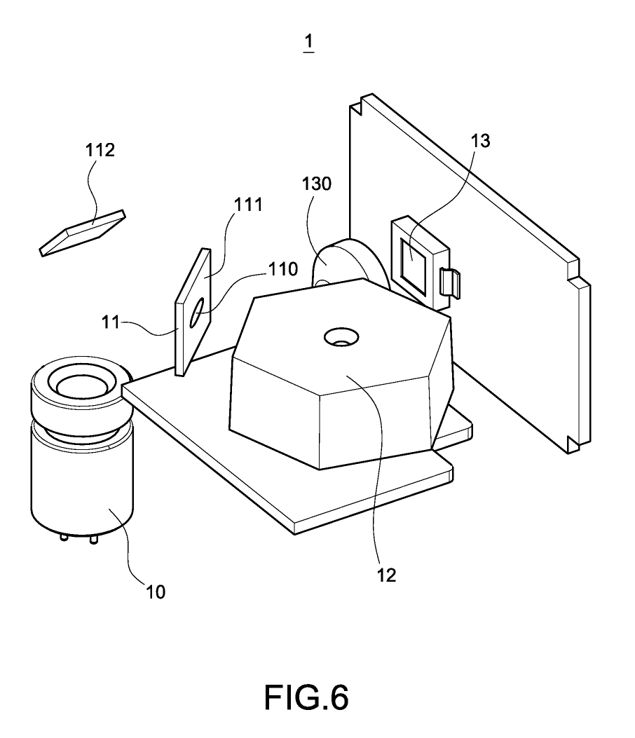

In FIGS. 4 and 5, the lens drum 12 is formed by surrounding six light reflecting surfaces 121, 122, 123, 124, 125, 126 around the external sides of the lens drum 12, and other embodiments may adopt 4, 5, 7 or 8 sides as well. The light generator 10 can be situated at a side proximate to the mirror 11, such that after a refracting plate 112 refracts the produced light beam, the light beam is passed through the penetrating hole 111 of the mirror 11. In this embodiment, the light generator 10 and the optical sensor 13 are installed on the same side to facilitate the scanning module 1 to further reduce its space and achieve a configuration that does not occupy much space. Of course, the light generator 10 can be installed at another position as shown in FIG. 6.

Meanwhile, the optical sensor 13 can install a focusing lens 130 at the front of the optical sensor 13 for focusing the returned light beam at the optical sensor 13 to increase the signal intensity. In addition, the scanning module 1 further includes a modularized housing 14 for accommodating the aforementioned components, and the housing 14 includes an upper casing 140 and a base 141 disposed under the upper casing 140 for installing and containing the components, so as to form a modularized scanning module 1.

In summation of the description above, the present invention provides a novel product to achieve the expected result and overcome the shortcomings of the prior art. Obviously, the invention complies with the patent application requirements, and thus is duly filed for patent application.

While the invention is described in by way of example and in terms of preferred embodiments, it is to be understood that the invention is not limited thereto. On the contrary, the aim is to cover all modifications, alternatives and equivalents falling within the spirit and scope of the invention as defined by the appended claims.

What is claimed is:

1. An optical scanning module of a barcode scanner for scanning a barcode, comprising:
an optical sensor;
a lens drum, having an axle disposed longitudinally at the center of the lens drum, and a plurality of light reflecting surfaces disposed continuously around external sides of the lens drum;
a mirror, having a reflecting plane, and disposed on a lateral side of the lens drum, such that the reflecting plane faces any one of the light reflecting surfaces, and the mirror having a penetrating hole disposed thereon for passing the reflecting plane; and
a light generator, for emitting a light beam through the penetrating hole of the mirror, projecting the light beam onto any one of the light reflecting surfaces of the lens drum, refracting the light beam to the barcode, returning the scanned light beam onto any one of the light reflecting surfaces of the lens drum, and refracting to the reflecting plane of the mirror, and the reflecting plane reflecting the returned light beam to the optical sensor for receiving the returned beam.

2. The optical scanning module of a barcode scanner as recited in claim 1, wherein the light reflecting surfaces of the lens drum come with a quantity of six.

3. The optical scanning module of a barcode scanner as recited in claim 1, wherein the light reflecting surfaces of the lens drum form a slope, and the slope of each light reflecting surface is not equal to the slope of other light reflecting surfaces.

4. The optical scanning module of a barcode scanner as recited in claim 1, wherein the light generator is disposed at the rear side of the mirror.

5. The optical scanning module of a barcode scanner as recited in claim 1, wherein the light generator is situated at a lateral side proximate to the mirror, for refracting a generated light by a refracting plate, and then passing the light through the penetrating hole of the mirror.

6. The optical scanning module of a barcode scanner as recited in claim 5, wherein the light generator and the optical sensor are situated on the same side.

7. The optical scanning module of a barcode scanner as recited in claim 1, wherein the optical sensor has a focusing lens installed at a front end of the optical sensor.

8. The optical scanning module of a barcode scanner as recited in claim 1, wherein the scanning module further comprises a housing for containing the optical sensor, the lens drum, the mirror and the light generator.

9. The optical scanning module of a barcode scanner as recited in claim 8, wherein the housing comprises an upper casing and a base disposed under the upper casing.
